(19) United States
(12) Patent Application Publication
(10) Pub. No.: US 2026/0196080 A1
(43) Pub. Date: Jul. 9, 2026

(54) MULTI-LEVEL SMARTPHONE SIDE CAMERA AND ONE-TIME CODE VERIFICATION FOR ONLINE EXAM PROCTORING

(71) Applicants: Constructor Technology AG, Schaffhausen (CH); Constructor Education and Research Genossenschaft, Schaffhausen (CH)

(72) Inventors: Rasilia Rakhmatulina, Sofia (BG); Andrey Adashchik, Sofia (BG); Sergey Ulasen, Singapore (SG); Serg Bell, Singapore (SG); Stanislav Protasov, Singapore (SG); Nikolay Dobrovolskiy, Alanya (TR); Laurent Dedenis, Geneve (CH)

(21) Appl. No.: 19/554,798

(22) Filed: Mar. 3, 2026

Related U.S. Application Data
(63) Continuation-in-part of application No. 19/034,694, filed on Jan. 23, 2025.
(63) Continuation-in-part of application No. 19/004,064, filed on Dec. 27, 2024, now Pat. No. 12,531,002.

(51) Int. Cl. G06V 40/40; G06F 3/01; G06T 7/20; G06V 40/20; H04L 9/32

(52) U.S. Cl. CPC G06V 40/40; G06F 3/012; G06F 3/013; G06T 7/20; G06V 40/28; H04L 9/3271

(57) ABSTRACT

Aspects of the present disclosure include a method for verifying live user presence in an online session, comprising receiving first and second video streams capturing a user during the session from a first position and a different second position, respectively. The method further comprises initiating a challenge by providing, for presentation on a different second display of a second device, a code, and providing, for presentation on a first display, an instruction to the user to respond to the challenge using the second device. The method further comprises detecting, based on at least one of the video streams, physical actions of the user during the challenge, receiving, from the second device, user input events representing a user response to the challenge, and determining, based on at least one of the physical actions or the user input events, whether the user successfully completed the challenge.

### CROSS-REFERENCE TO RELATED APPLICATIONS

This application is a continuation-in-part of and claims the benefit of priority to both U.S. Patent Application No. 19/034,694, filed on January 23, 2025 and entitled “PROCTORING OF ONLINE EXAMINATIONS USING GAZE DETERMINATION,” and U.S. Patent Application No. 19/004,064, filed on December 27, 2024 and entitled “SYSTEMS AND METHODS FOR DETECTION OF THE PRESENCE OF A PERSON IN FRONT OF ADISPLAY WITH A CAMERA,” the contents of which are incorporated by reference herein in the entirety.

### FIELD OF TECHNOLOGY

The present disclosure relates to the field of online presence and liveness verification, and, more specifically, to systems and methods for verifying live user presence in an online session across multiple levels utilizing a secondary camera and a one-time code verification.

### BACKGROUND

A deepfake is an artificial image or video.

Examinations are now commonly taken on computers, offering convenience and accessibility for both learners and institutions. These computer examinations are conducted through specialized software or platforms that allow learners to take tests from remote locations. They often include features like automated proctoring, time tracking, and instant grading. However, this shift to computer examinations has also introduced new opportunities for cheating. Learners might use unauthorized resources such as notes, search engines, or communication tools like messaging apps during the exam. Other learners may simply have someone else pretend to be the learner and take the computer examination for the learner under the learner’s login credentials. In other cases, in examinations with video proctoring, a pre-recorded video loop or a deepfake of the candidate sitting still or pretending to take the exam could be played while the real exam is being taken by someone else. These methods exploit the weaknesses in online proctoring systems, especially in cases where human proctors or artificial intelligence (AI) may not be able to detect subtle signs of cheating. Therefore, there is a need to strengthen online presence and liveness verification during online sessions (e.g., remote exams or remote proctoring) against deepfakes, prerecorded video, and remote helpers

### SUMMARY

This summary is provided to introduce a selection of concepts in a simplified form that are further described below in the DETAILED DESCRIPTION. This summary is not intended to identify key features of the claimed subject matter, nor is it intended to be used as an aid in determining the scope of the claimed subject matter.

One aspect of the present disclosure includes a method for verifying live user presence in an online session. The method comprises receiving a first video data stream of a user during the online session, and receiving a second video data stream of the user during the online session. The first video data stream captures the user from a first position relative to a first display of a first computing device. The second video data stream captures the user from a different second position relative to the first display. The method further comprises initiating a challenge by providing, for presentation on a different second display of a different second computing device, a challenge code, and providing, for presentation on the first display, an instruction to the user to respond to the challenge using the second computing device. The method further comprises detecting, based on at least one of the first video data stream or the second video data stream, one or more physical actions of the user during the challenge, receiving, from the second computing device, one or more user input events representing a user response to the challenge, and determining, based on at least one of the detected physical actions or the received user input events, whether the user successfully completed the challenge.

Another aspect of the present disclosure includes a system for verifying live user presence in an online session. The system comprises one or more memories configured to store executable instructions, and one or more processors communicatively coupled with the one or more memories. The one or more processors are configured, individually or in any combination, to execute the executable instructions to receive a first video data stream of a user during the online session, and receive a second video data stream of the user during the online session. The first video data stream captures the user from a first position relative to a first display of a first computing device. The second video data stream captures the user from a different second position relative to the first display. The one or more processors are further configured, individually or in any combination, to execute the executable instructions to initiate a challenge by providing, for presentation on a different second display of a different second computing device, a challenge code, and provide, for presentation on the first display, an instruction to the user to respond to the challenge using the second computing device. The one or more processors are further configured, individually or in any combination, to execute the executable instructions to detect, based on at least one of the first video data stream or the second video data stream, one or more physical actions of the user during the challenge, receive, from the second computing device, one or more user input events representing a user response to the challenge, and determine, based on at least one of the detected physical actions or the received user input events, whether the user successfully completed the challenge.

Another aspect of the present disclosure includes a non-transitory computer-readable medium having instructions for verifying live user presence in an online session. The instructions are executable by one or more processors, individually or in any combination, to receive a first video data stream of a user during the online session, and receive a second video data stream of the user during the online session. The first video data stream captures the user from a first position relative to a first display of a first computing device. The second video data stream captures the user from a different second position relative to the first display. The instructions are further executable by the one or more processors, individually or in any combination, to initiate a challenge by providing, for presentation on a different second display of a different second computing device, a challenge code, and provide, for presentation on the first display, an instruction to the user to respond to the challenge using the second computing device. The instructions are further executable by the one or more processors, individually or in any combination, to execute the executable instructions to detect, based on at least one of the first video data stream or the second video data stream, one or more physical actions of the user during the challenge, receive, from the second computing device, one or more user input events representing a user response to the challenge, and determine, based on at least one of the detected physical actions or the received user input events, whether the user successfully completed the challenge.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram of an example environment for verifying live user presence in an online session, according to some aspects of the present disclosure;

FIG. 2 is a block diagram of an example multi-level challenge verification module, according to some aspects of the present disclosure;

FIG. 3 is a block diagram of an example decision and escalation module, according to some aspects of the present disclosure;

FIG. 4A is an example first instruction presented during an online session, according to some aspects of the present disclosure;

FIG. 4B is an example second instruction presented during the same online session of FIG. 4A, according to some aspects of the present disclosure;

FIG. 4C is one or more example physical actions detected during the same online session of FIG. 4A, according to some aspects of the present disclosure;

FIG. 4D is one or more example additional physical actions detected during the same online session of FIG. 4A, according to some aspects of the present disclosure;

FIG. 5 is flow diagram of an example method for verifying live user presence in an online session, according to some aspects of the present disclosure; and

FIG. 6 presents an example of a general-purpose computer system on which aspects of the present disclosure can be implemented.

### DETAILED DESCRIPTION

Aspects of the disclosure improve online presence and liveness verification during online sessions (e.g., remote exams or remote proctoring) against deepfakes, prerecorded video, and remote helpers. Aspects of the disclosure increase the reliability of online exam proctoring by using an examinee’s smartphone or other computing device as a secondary camera and challenge device (i.e., secondary device), and enforcing multiple escalating levels of online presence and liveness verification (i.e., multiple levels of protection). The levels include: (1) a first level for verifying that when a challenge appears on the challenge device, the examinee turns their head towards the challenge device, (2) a second level for verifying that the examinee moves a hand towards the challenge device and enters a code of the challenge on it by correlating video from the side camera with touch input events on the challenge device, and (3) a third level for verifying that the examinee’s gaze is directed towards a display of the challenge device during reading and/or input of the code. Aspects of the disclosure detects scenarios where another person is interacting with the challenge device, or where the code is being relayed to a helper, even though a face is visible at a main camera separate from the secondary camera and the challenge device. Aspects of the disclosure provide a robust, hard to spoof liveness and user identity check during online sessions by combining use of two different camera (a main camera and the secondary camera) with a multi-level online presence and liveness verification process.

Exemplary aspects are described herein in the context of a system, a method, and a non-transitory computer-readable medium for verifying live user presence in an online session. Aspects of the present disclosure include receiving a first video data stream of a user during the online session, receiving a second video data stream of the user during the online session, initiating a challenge by providing, for presentation on a different second display of a different second computing device, a challenge code, providing, for presentation on a first display of a first computing device, an instruction to the user to respond to the challenge using the second computing device, detecting, based on at least one of the first video data stream or the second video data stream, one or more physical actions of the user during the challenge, receiving, from the second computing device, one or more user input events representing a user response to the challenge, and determining, based on at least one of the detected physical actions or the received user input events, whether the user successfully completed the challenge. The first video data stream captures the user from a first position relative to the first display, and the second video data stream captures the user from a different second position relative to the first display.

In one aspect, the instruction and the challenge code are simultaneously presented on the first display and the second display, respectively.

In one aspect, the first video data stream is captured via a first camera of the first computing device, and the second video data stream is captured via a second camera of the second computing device.

In one aspect, the second computing device is positioned to a side of the first computing device, and the second computing device is positioned to a side of the user when the user is in front of and facing the first display.

In one aspect, the second computing device comprises a smartphone.

In one aspect, the online session comprises an online examination session, and the user is an examinee.

In one aspect, examination content is provided for presentation on the first display in response to determining the user successfully completed the challenge.

In one aspect, at least one action is triggered in response to determining the user did not successfully complete the challenge, where the at least one action comprises at least one of pausing the online examination session, notifying a proctor, initiating an additional challenge, or recording that the user did not successfully complete the challenge.

In one aspect, the detecting comprises determining, based on the first video stream, whether a head of the user rotates towards the second computing device during the challenge, and determining, based on the second video stream, whether a face of the user orientates towards the second display during the challenge.

In one aspect, the detecting further comprises detecting, in one or more individual video frames of the second video stream, at least one hand region of the user corresponding to a physical action of the user, tracking a movement of the at least one hand region during the challenge, and determining, based on the tracked movement, whether the at least one hand region moves from outside of a region proximate to the second computing device to inside of the region during the challenge.

In one aspect, the detecting further comprises determining a time interval during which the at least one hand region moves towards the second computing device, and determining whether one or more timestamps of the received user input events fall within the time interval.

In one aspect, the detecting further comprises estimating, based on at least one of the first video stream or the second video stream, a gaze direction of the user during the challenge, and determining whether the gaze direction is directed towards the second display for a pre-determined duration, where the pre-determined duration represents a minimum amount of time required to at least one of read the challenge code on the second display or respond to the challenge using the second computing device.

In one aspect, the determining comprises determining whether the user physically interacted with the second computing device during the challenge, determining whether the user response matches the challenge code, and determining the user did not successfully complete the challenge in response to determining at least one of the user did not physically interact with the second computing device during the challenge or the user response does not match the challenge code.

In one aspect, the user did not physically interact with the second computing device during the challenge if the head of the user does not rotate towards the second computing during the challenge, the face of the user does not orientate towards the second display during the challenge, the at least one hand region does not move from outside of the region to inside of the region during the challenge, the timestamps of the received user input events do not fall within the time interval, or the gaze direction is not directed towards the second display for the pre-determined duration.

Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

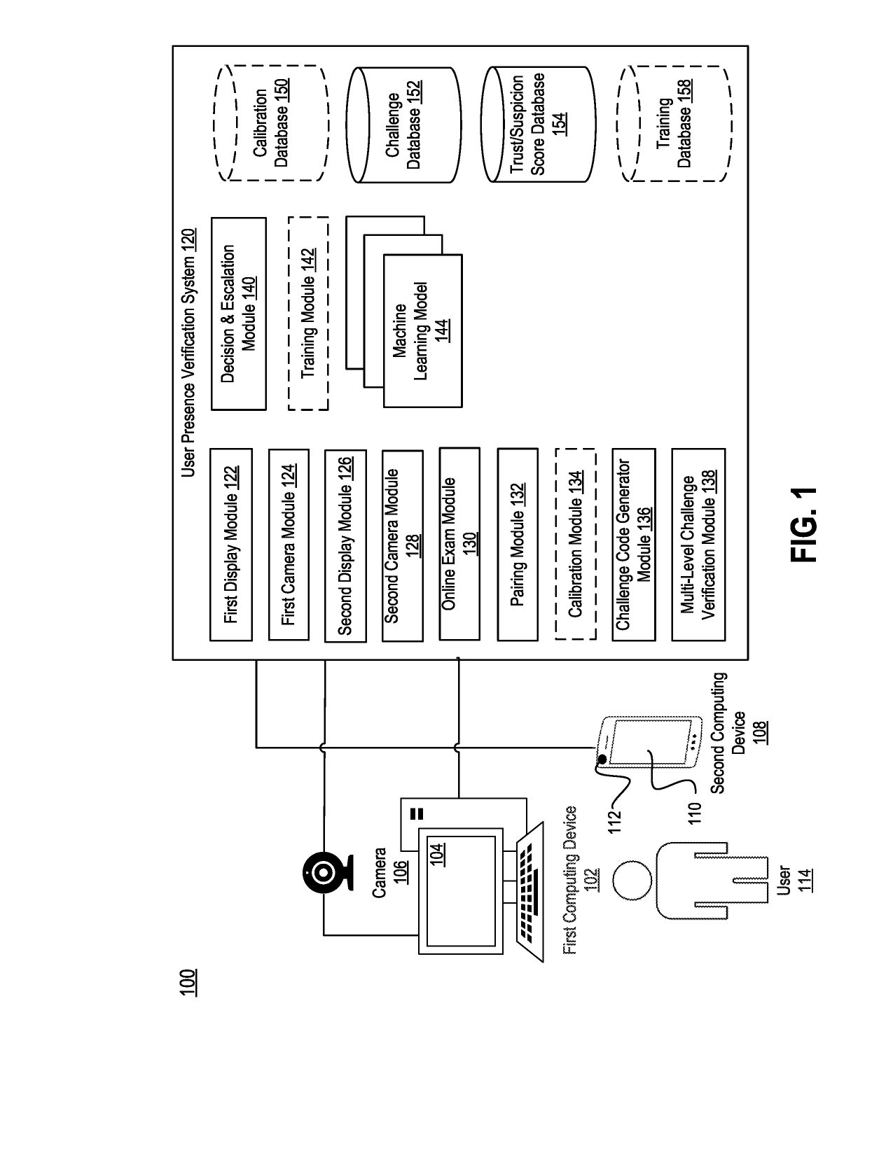

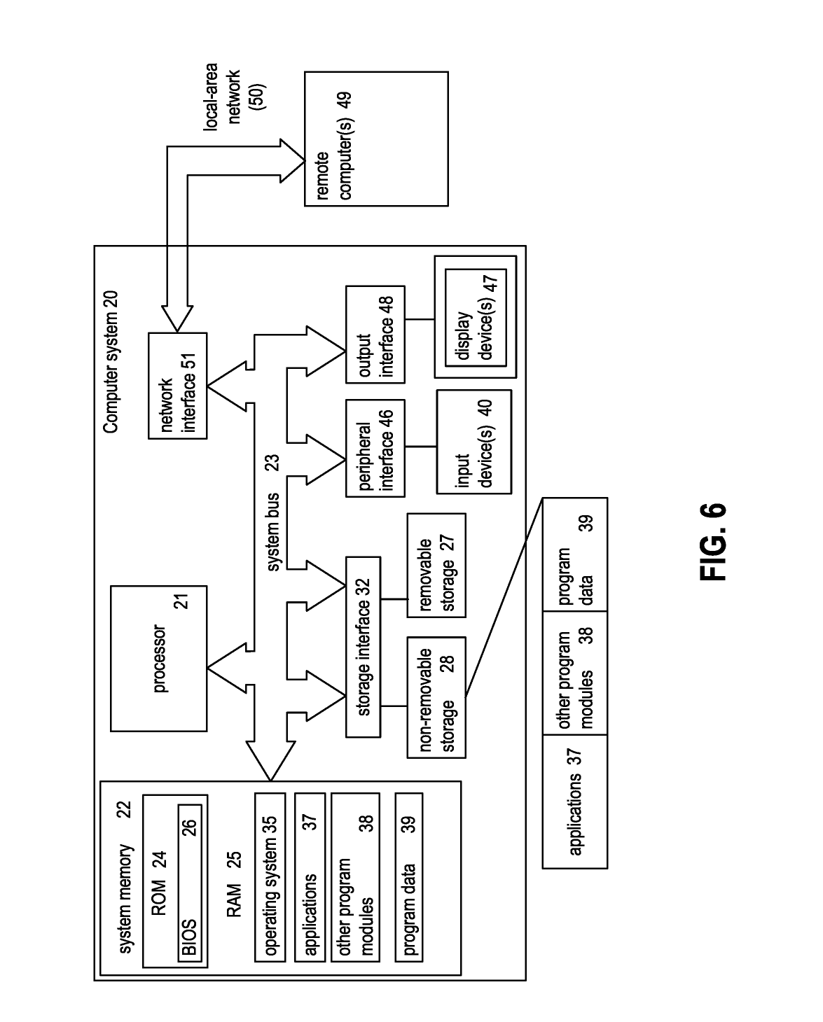

FIG. 1 is a block diagram of an example environment 100 for verifying live user presence in an online session, according to some aspects of the present disclosure. In some aspects, the environment 100 includes a first computing device 102 and a second computing device 108. In some aspects, each of the computing device 102, 108 in FIG. 1 is implemented as a computer system 20 in FIG. 6. Examples of a computing device 102/108 include, but are not limited to, a mobile phone, a smart phone, a laptop, a tablet computer, a personal digital assistant, a wearable device (e.g., a smart watch, a head-mounted display, smart glasses, etc.), a desktop computer, a gaming console, an Internet of Things (IoT) device, and/or other computerized devices.

At least one of the first computing device 102 or the second computing device 108 executes a user presence verification system 120, which may be a standalone online presence and liveness verification software or a software component providing one or more online presence and liveness verification tools. The first computing device 102 allows a user 114 to participate in an online session administered and/or proctored by the user presence verification system 120. As described in detail later herein, the user presence verification system 120 leverages different cameras (e.g., camera 106, and camera 112) and advanced computer vision and/or machine learning techniques to verify live presence of the user during the online session. In one non-limiting example aspect, the online session comprises an online examination administered and proctored by the user presence verification system 120.

In some aspects, the environment 100 includes a first electronic display (“first display”) 104 for displaying on-screen content. The first display 104 is coupled to, or integrated in, the first computing device 102. In one non-limiting example aspect, the first display 104 is positioned in front of a user 114.

In some aspects, the environment 100 includes a first camera 106 for capturing a video data stream. In one aspect, the first camera 106 is coupled to, or integrated in, the first computing device 102. In another aspect, the first camera 106 is coupled to the user presence verification system 120. The user presence verification system 120 can obtain one or more video data streams captured via the first camera 106. In one non-limiting example aspect, the first camera 106 is positioned in front of the user 114 and captures a first video data stream of the user 114 during an online session administered and/or proctored by the user presence verification system 120. The first video data stream captures the user 114 from a first position relative to the first display 104.

In some aspects, the environment 100 includes a second electronic display (“second display”) 110 for displaying on-screen content. The second display 110 is coupled to, or integrated in, the second computing device 108. In one non-limiting example aspect, during an online session administered and/or proctored by the user presence verification system 120, the second computing device 108/the second display 110 is positioned such that the second computing device 108/the second display 110 is: (1) to a side of the first computing device 102/first display 104, and (2) to a side of the user 114 when the user 114 is in front of and facing the first display 104.

In some aspects, the environment 100 includes a second camera 112 for capturing a video data stream. In one aspect, the second camera 112 is coupled to, or integrated in, the second computing device 108. In another aspect, the second camera 112 is coupled to the user presence verification system 120. The user presence verification system 120 can obtain one or more video data streams captured via the second camera 112. In one non-limiting example aspect, the second camera 106 is positioned to a side of the user 114 and captures a second video data stream of the user 114 during an online session administered and/or proctored by the user presence verification system 120. The second video data stream captures the user 114 from a different second position relative to the first display 104.

In some aspects, the first computing device 102 and the second computing device 108 are designated as a main device and a secondary device, respectively. In some aspects, the first display 104 and the second display 110 are designated as a main display and a secondary display, respectively. In some aspects, the first camera 106 and the second camera 112 are designated as a main camera and a secondary camera, respectively. The first camera 106 and the second camera 112 capture the user 114 from different positions during an online session administered and/or proctored by the user presence verification system 120.

The user presence verification system 120 includes a plurality of modules. At least one of the first computing device 102 or the second computing device 108 can execute at least one of the plurality of modules. In some aspects, the user presence verification system 120 can be implemented in the first computing device 102, the second computing device 108, or a cloud network (not shown) that is configured to execute the plurality of modules that together make up the user presence verification system 120.

In some aspects, the user presence verification system 120 includes a first display module 122 configured to generate one or more graphical user interfaces (GUIs), where each GUI includes content for presentation on the first display 104 during an online session administered and/or proctored by the user presence verification system 120.

In some aspects, the user presence verification system 120 includes a first camera module 124 configured for video acquisition. Specifically, the first camera module 124 is configured to: (1) trigger the first camera 106 to capture a continuous first video data stream of the user 114 during an online session administered and/or proctored by the user presence verification system 120, and (2) obtain the first video data stream of the user 114.

In some aspects, the user presence verification system 120 includes a second display module 126 configured to generate one or more graphical user interfaces (GUIs), where each GUI includes content for presentation on the second display 110 during an online session administered and/or proctored by the user presence verification system 120.

In some aspects, the user presence verification system 120 includes a second camera module 128 configured for video acquisition. Specifically, the second camera module 128 is configured to: (1) trigger the second camera 112 to capture a continuous second video data stream of the user 114 during an online session administered and/or proctored by the user presence verification system 120, and (2) obtain the second video data stream of the user 114.

In some aspects, the user presence verification system 120 includes an online examination module 130 configured to initialize an online session with the user 114, such as an online examination administered and proctored by the user presence verification system 120. The online examination module 130 is configured to monitor the progress (i.e., state) of the online session.

In some aspects, the user presence verification system 120 includes a pairing module 132 configured to pair the second computing device 108 with an online session administered and/or proctored by the user presence verification system 120. In some aspects, the user 114 pairs the second computing device 108 with the online session by inputting, via the second computing device 108, login information. The login information can be presented on the first display 104. In some aspects, the user 114 pairs the second computing device 108 with the online session by scanning, via the second camera 112, a QR code presented on the first display 104.

After the second computing device 108 is paired with the online session, the pairing module 132 is configured to invoke the first display module 122 to display a first instruction to the user 114 on the first display 104, where the first instruction prompts the user 114 to position or place the second computing device 108 to a side of the first computing device 102/first display 104 (e.g., “Place your phone to the right of the main display.”). For example, the user 114 can be instructed to position the second computing device 108 either to a right of or to a left of the first display 104. The second computing device 108 is positioned such that the second camera 112 is capable of capturing at least a side view of a head of the user 114 and a region where one or more hands of the user 114 can appear.

After the second computing device 108 is positioned to a side of the first computing device 102/first display 104, the pairing module 132 is configured to: (1) invoke the first camera module 124 which in turn triggers the first camera 106 to capture a continuous first video data stream of the user 114 during the online session, and (2) invoke the second camera module 128 which in turn triggers the second camera 112 to capture a continuous second video data stream of the user 114 during the online session.

In some aspects, the pairing module 132 is configured to provide, as outputs to one or more others modules of the user presence verification system 120, the first video data stream, the second video data stream, and an approximate position of the second computing device 108 (i.e., side position of the second computing device 108). In some aspects, the side position of the second computing device 108 is determined based on at least one of first video data stream or the second video data stream. In some aspects, the side position of the second computing device 108 is determined based on location coordinates received from the second computing device 108 and captured via one or more location sensors (not shown) (e.g., GPS) of the second computing device 108.

In some aspects, the user presence verification system 120 optionally includes a calibration module 134 configured to receive the first video data stream and the second video data stream (e.g., from the pairing module 132), and perform a calibration process (e.g., at the start of the online session) based on the video data streams received. The calibration process includes estimating, based on the first video data stream, a baseline pose of a head (“baseline head pose”) of the user 114 when the user 114 is looking at the first display 104. The calibration process further includes detecting, based on the second video data stream, a facial region and one or more hand regions representing a face and one or more hands, respectively, of the user 114. The calibration process further includes estimating one or more distances and/or one or more angles between the secondary computing device 108/the second display 110 and at least one of the head of the user 114 or the hands of the user 114.

In some aspects, the calibration process optionally includes calibrating a head orientation and a gaze direction of the user 114 from the side position of the second computing device 108 by: (1) invoking the second display module 126 to display one or more short prompts on the second display 110, and (2) invoking the second camera module 128 to trigger the second camera 112 to capture a few video frames of the user 114 while the user 114 is looking directly at the second display 110 (e.g., reading the one or more short prompts displayed).

In some aspects, the calibration module 134 is configured to provide, to one or more others modules of the user presence verification system 120, calibration data relating to the user 114. In some aspects, the calibration data comprises, but is not limited to, at least one of the following: one or more baseline head pose parameters based on the baseline head pose of the user 114; optionally, one or more gaze direction parameters based on the gaze direction of the user 114 from the side position of the second computing device 108; and an approximate mapping between a head orientation of the user 114 from the side position and a direction of the second computing device 108.

In some aspects, the calibration process ensures that a field of view (FOV) for monitoring the user 114 is appropriately set up, i.e., the user 114 is correctly framed in the FOV of the first camera 106 and the second camera 112. The calibration process is critical to validate the integrity of an environment of the user 114 during the online (e.g., an examination-taking environment if the online session comprises an online examination). In some aspects, the calibration data relating to the user 114 (e.g., baseline head pose parameters, gaze direction parameters, mapping, etc.) can be stored in an optional database 150 (e.g., calibration database).

In some aspects, the user presence verification system 120 includes a challenge code generator module 136 configured to receive, as input, a state of the online session (e.g., from the online exam module 130), where the state of the online session is indicative of a progression of the online session (e.g., question index) and/or whether the online session is potentially suspicious (e.g., trust/suspicion score). The challenge code generator module 136 is configured to generate, at a random time or when a suspicious condition is met (e.g., trust/suspicion score fall below a pre-defined threshold), a challenge code corresponding to a challenge in which a live presence of the user 114 is verified (i.e., liveness check). In some aspects, the challenge code comprises at least one of a multi-digit code or a pattern (e.g., a spatial and/or temporal pattern). The challenge code generator module 136 is configured to initiate the challenge by: (1) invoking the second display module 126 to display the challenge code on the second display 110, and (2) invoking the first display module 122 to display a second instruction to the user 114 on the first display 104, where the second instruction prompts the user 114 to look at the second display 110 and input the challenge code using the second computing device 108 (e.g., “Look at your phone and enter the code shown on it”). In some aspects, the challenge code and the second instruction are simultaneously displayed on the second display 110 and the first display 104, respectively.

In some aspects, the challenge code generator module 136 is configured to provide, to one or more others modules of the user presence verification system 120, at least one of the following outputs: the challenge code; the second instruction; or a recorded start time of the challenge (i.e., when the challenge was initiated). In some aspects, the challenge code, the second instruction, and the recorded start time can be stored in a database 152 (e.g., challenge database).

In some aspects, the user presence verification system 120 includes a multi-level challenge verification module 138 configured to receive, as inputs, the first video data stream and the second video data stream (e.g., from the pairing module 132), the side position of the second computing device 108 (e.g., from the pairing module 132), a recorded start time of a challenge (e.g., from the challenge code generator module 136), one or more touch input events from the second computing device 108, and, optionally, calibration data relating to the user 114 (e.g., from the database 150). The one or more touch input events from the second computing device 108 represent an inputted code by the user 114 during the challenge.

The multi-level challenge verification module 138 implements a multi-level online presence and liveness verification process (“multi-level verification process”). In some aspects, the multi-level verification process includes a first level for verifying whether the user 114 made a head turn towards the second computing device 108/second display 110 during a challenge. In the first level, utilizing at least one machine learning model 144, the multi-level challenge verification module 138 is configured to estimate a head orientation of the user 114 during the challenge, based on a subset of video frames of the first video data stream, where the subset spans from before a recorded start time of the challenge (e.g., the recorded start time minus a pre-defined offset) to after the recorded start time. In the first level, the multi-level challenge verification module 138 is further configured to make a first determination, based on the calibration data relating to the user 114 and the side position of the second computing device 108, of whether the estimated head orientation rotates towards the second computing device 108/second display 110 by more than pre-defined threshold angle within a pre-defined reaction time window. In the first level, the multi-level challenge verification module 138 is further configured to make a second determination of whether a facial region of the user 114 appears with an orientation compatible with looking towards the second computing device 108/second display 110, based on one or more video frames of the second video data stream. Based on at least one of the first determination or the second determination, the multi-level challenge verification module 138 is configured to determine a first level score for the challenge, where the first level score is indicative of whether the user 114 is verified to have made a head turn towards the second computing device 108/second display 110 during the challenge. In some aspects, the first level score is a binary pass/fail decision.

In some aspects, the multi-level verification process includes a second level for verifying: (1) whether the user 114 made one or more hand movements towards the second computing device 108/second display 110 during a challenge, and (2) whether one or more touch input events from the second computing device 108 substantially matches a challenge code corresponding to the challenge. In the second level, utilizing at least one machine learning model 144, the multi-level challenge verification module 138 is configured to detect one or more hand regions of the user 114 and track movement of the one or more hand regions during the challenge, based on one or more video frames of the second video data stream. In the second level, the multi-level challenge verification module 138 is further configured to make a third determination of whether at least one hand of the user 114 moves from outside a vicinity of the second computing device 108/second display 110 and into the vicinity of the second computing device 108/second display 110 during the challenge, based on the tracked movement of the one or more hand regions. In the second level, the multi-level challenge verification module 138 is further configured to make a fourth determination of whether one or more timestamps of the one or more touch input events fall within a time window during which the at least one hand of the user 114 moves from outside the vicinity of the second computing device 108/second display 110 and into the vicinity of the second computing device 108/second display 110 (i.e., verifying for temporal correspondence). In the second level, the multi-level challenge verification module 138 is further configured to make a fifth determination of whether an inputted code represented by the one or more touch input events substantially matches the challenge code. Based on at least one of the third determination, the fourth determination, or the fifth determination, the multi-level challenge verification module 138 is configured to determine a second level score for the challenge, where the second level score is indicative of whether: (1) the user 114 is verified to have made one or more hand movements towards the second computing device 108/second display 110 during the challenge, and (2) the inputted code is verified to have substantially matched the challenge code. In some aspects, the second level score is a binary pass/fail decision.

In some aspects, the multi-level verification process includes a third level for verifying whether a gaze of one or more eyes of the user 114 is directed towards the second display 110 during the challenge. In the third level, utilizing at least one machine learning model 144 or a gaze estimation algorithm, the multi-level challenge verification module 138 is configured to estimate a gaze direction of the user 114, based on at least one of one or more video frames of the first video data stream or one or more video frames of the second video data stream. In the third level, the multi-level challenge verification module 138 is further configured to map the estimated gaze direction to a region that includes the second display 110. In the third level, the multi-level challenge verification module 138 is further configured to make a sixth determination of whether a gaze of the user 114 is directed towards the second display 110 for at least a minimum cumulative duration while the challenge is visible on the second display 110 and/or while the one or more touch input events occur, based on the map and the estimated gaze direction. Based on at least the sixth determination, the multi-level challenge verification module 138 is configured to determine a third level score for the challenge, where the third level score is indicative of whether the gaze of the user 114 is verified to have been directed towards the second display 110 during the challenge. In some aspects, the third level score is a binary pass/fail decision.

In some aspects, the first level, the second level, and the third level of the multi-level verification process occurs in parallel.

In some aspects, the user presence verification system 120 includes a decision and escalation module 140 configured to receive, as inputs, one or more pre-defined thresholds and multiple level scores for a challenge, including a first level score, a second level score, and a third level score (e.g., from the multi-level challenge verification module 138). The decision and escalation module 140 is configured to combine each level score received for the challenge into a trust/suspicion score for the challenge (e.g., using weighted sum). In some aspects, the decision and escalation module 140 is configured to determine whether the trust/suspicion score meets or exceeds a first pre-defined threshold. If the trust/suspicion score meets or exceeds the first pre-defined threshold, the decision and escalation module 140 makes a determination that the user 114 successfully performed the challenge. If the trust/suspicion score is less than the first pre-defined threshold but meets or exceeds a second pre-defined threshold, the decision and escalation module 140 is configured to optionally repeat the challenge or trigger one or more additional and different challenges (e.g., by invoking the challenge code generator module 136). If the trust/suspicion score is less than the second pre-defined threshold or if the user 114 failed multiple challenges, the decision and escalation module 140 is configured to generate an incident record and perform at least one of the following actions: escalate to a human proctor for manual review (e.g., generate and transmit an optional alert to the human proctor); pause, terminate, or invalidate the online session (e.g., pause, terminate, or invalidate the online examination); or trigger one or more other online presence and liveness verification processes (e.g., reflection-based liveness checks).

In some aspects, the decision and escalation module 140 is configured to aggregate multiple trust/suspicion scores for multiple challenges over the course of the online session into a final decision (e.g., using weighted averaging or voting over the scores). The decision and escalation module 140 is further configured to update a trust/suspicion score for the online session based on the final decision. In some aspects, the trust/suspicion score can be stored in a database 154 (e.g., trust/suspicion score database).

In some aspects, the user presence verification system 120 optionally includes a training module 142 and a training database 158 including one or more sets of training data. The training module 142 is configured to train or update (e.g., finetune) at least one machine learning model 144 based on at least one set of training data from the training database 158.

In some aspects, the user presence verification system 120 is configured to run on a standard end user device or consumer device, such as the computing device 102. In some aspects, the user presence verification system 120 is compatible with both web-based and native application environments. In some aspects, the user presence verification system 120 requires no specialized hardware components or resources, and can utilize standard hardware resources (e.g., a central processing unit (CPU), a graphical processing unit (GPU), and/or a memory) already available in standard end user devices or consumer devices. In some aspects, the user presence verification system 120 can be deployed on cloud servers for enterprise-scale application scenarios.

In some aspects, the user presence verification system 120 is integrated into, or implemented as part of, educational and training platforms.

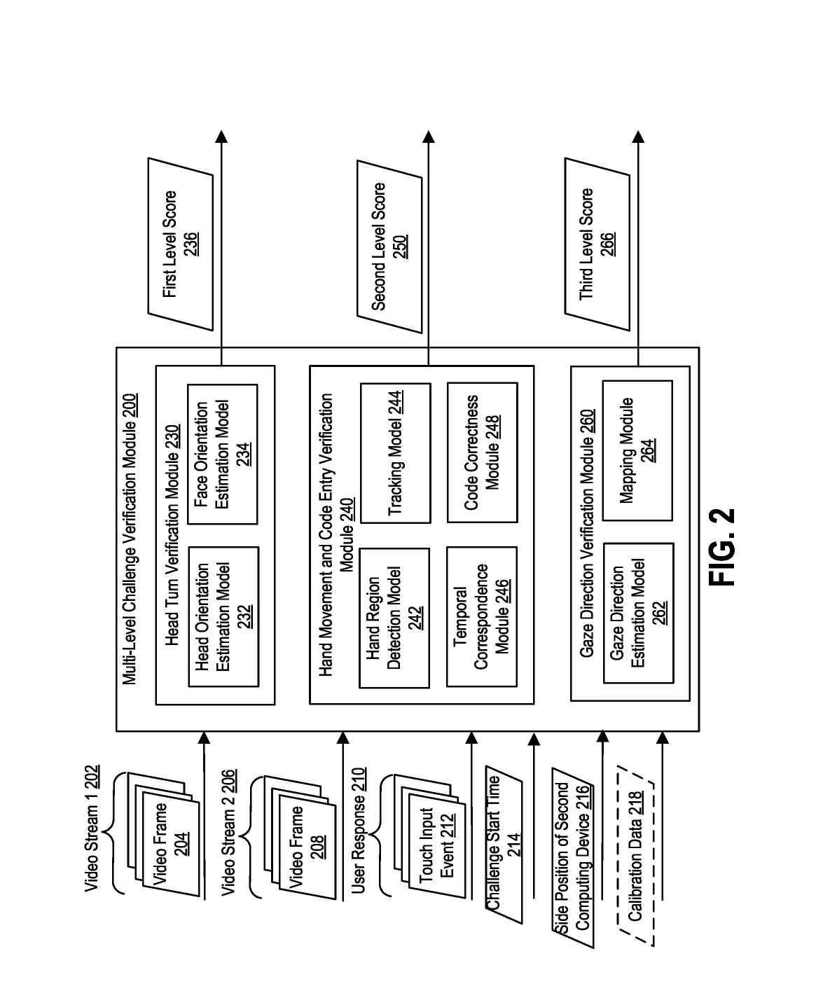

FIG. 2 is a block diagram of an example multi-level challenge verification module 200, according to some aspects of the present disclosure. In some aspects, the multi-level challenge verification module 138 in FIG. 1 is implemented as the multi-level challenge verification module 200.

In some aspects, the multi-level challenge verification module 200 implements a multi-level verification process. In some aspects, the multi-level challenge verification module 200 includes a head turn verification module 230 configured to perform a first level of the multi-level verification process, where the first level comprises verifying whether the user 114 (FIG. 1) made a head turn towards the second computing device 108/second display 110 (FIG. 1) during a challenge.

In some aspects, the head turn verification module 230 utilizes a head orientation estimation model 232 to estimate a head orientation of the user 114 during the challenge, based on a subset of video frames 204 of a first video data stream 202 captured by the first camera 106 (FIG. 1). In some aspects, the subset spans from before a recorded start time 214 of the challenge (e.g., the recorded start time 214 minus a pre-defined offset) to after the recorded start time 214. In some aspects, the head turn verification module 230 makes a first determination, based on calibration data 218 relating to the user 114 and a side position 216 of the second computing device 108, of whether the estimated head orientation rotates towards the second computing device 108/second display 110 by more than pre-defined threshold angle within a pre-defined reaction time window.

In some aspects, the head turn verification module 230 utilizes a face orientation estimation model 234 to make a second determination of whether a facial region of the user 114 appears with an orientation compatible with looking towards the second computing device 108/second display 110, based on one or more video frames 208 of a second video data stream 206 captured by the second camera 112 (FIG. 1).

In some aspects, each of the models 232, 234 is a machine learning model.

In some aspects, based on at least one of the first determination or the second determination, the head turn verification module 230 outputs a first level score 236 for the challenge, where the first level score 236 is indicative of whether the user 114 is verified to have made a head turn towards the second computing device 108/second display 110 during the challenge. In some aspects, the first level score 236 is a binary pass/fail decision.

In some aspects, the multi-level challenge verification module 200 includes a hand movement and code entry verification module 240 configured to perform a second level of the multi-level verification process, where the second level comprises verifying: (1) whether the user 114 made one or more hand movements towards the second computing device 108/second display 110 during a challenge, and (2) whether one or more touch input events 212 from the second computing device 108 substantially matches a challenge code corresponding to the challenge.

In some aspects, the hand movement and code entry verification module 240 utilizes a hand region detection model 242 to detect one or more hand regions of the user 114, based on one or more video frames 208 of the second video data stream 206. In some aspects, the hand movement and code entry verification module 240 utilizes a tracking model 244 to track movement of the one or more hand regions during the challenge, based on one or more video frames 208 of the second video data stream 206.

In some aspects, each of the models 242, 244 is a machine learning model.

In some aspects, the hand movement and code entry verification module 240 includes a temporal correspondence module 246 configured to: (1) make a third determination of whether at least one hand of the user 114 moves from outside a vicinity of the second computing device 108/second display 110 and into the vicinity of the second computing device 108/second display 110 during the challenge, based on the tracked movement of the one or more hand regions, and (2) make a fourth determination of whether one or more timestamps of the one or more touch input events 212 fall within a time window during which the at least one hand of the user 114 moves from outside the vicinity of the second computing device 108/second display 110 and into the vicinity of the second computing device 108/second display 110 (i.e., verifying for temporal correspondence).

In some aspects, the hand movement and code entry verification module 240 includes a code correctness module 248 configured to make a fifth determination of whether an inputted code represented by the one or more touch input events 212 substantially matches the challenge code.

In some aspects, based on at least one of the third determination, the fourth determination, or the fifth determination, the hand movement and code entry verification module 240 outputs a second level score 250 for the challenge, where the second level score 250 is indicative of whether: (1) the user 114 is verified to have made one or more hand movements towards the second computing device 108/second display 110 during the challenge, and (2) the inputted code is verified to have substantially matched the challenge code. In some aspects, the second level score 250 is a binary pass/fail decision.

In some aspects, the multi-level challenge verification module 200 includes a gaze direction verification module 260 configured to perform a third level of the multi-level verification process, where the third level comprises verifying whether a gaze of the user 114 is directed towards the second display 110 during the challenge.

In some aspects, the gaze direction verification module 260 utilizes a gaze direction estimation model 262 or a gaze estimation algorithm to estimate a gaze direction of the user 114, based on at least one of one or more video frames 204 of the first video data stream 202 or one or more video frames 208 of the second video data stream 206. In some aspects, the gaze direction verification module 260 includes a mapping module 264 for mapping the estimated gaze direction to a region that includes the second display 110. The gaze direction verification module 260 makes a sixth determination of whether a gaze of the user 114 is directed towards the second display 110 for at least a minimum cumulative duration while the challenge is visible on the second display 110 and/or while the one or more touch input events 212 occur, based on the mapping and the estimated gaze direction.

In some aspects, the model 262 is a machine learning model.

In some aspects, based on at least the sixth determination, the gaze direction verification module 260 outputs a third level score 266 for the challenge, where the third level score 266 is indicative of whether the gaze of the user 114 is verified to have been directed towards the second display 110 during the challenge. In some aspects, the third level score 266 is a binary pass/fail decision.

In some aspects, the first level, the second level, and the third level of the multi-level verification process occurs in parallel.

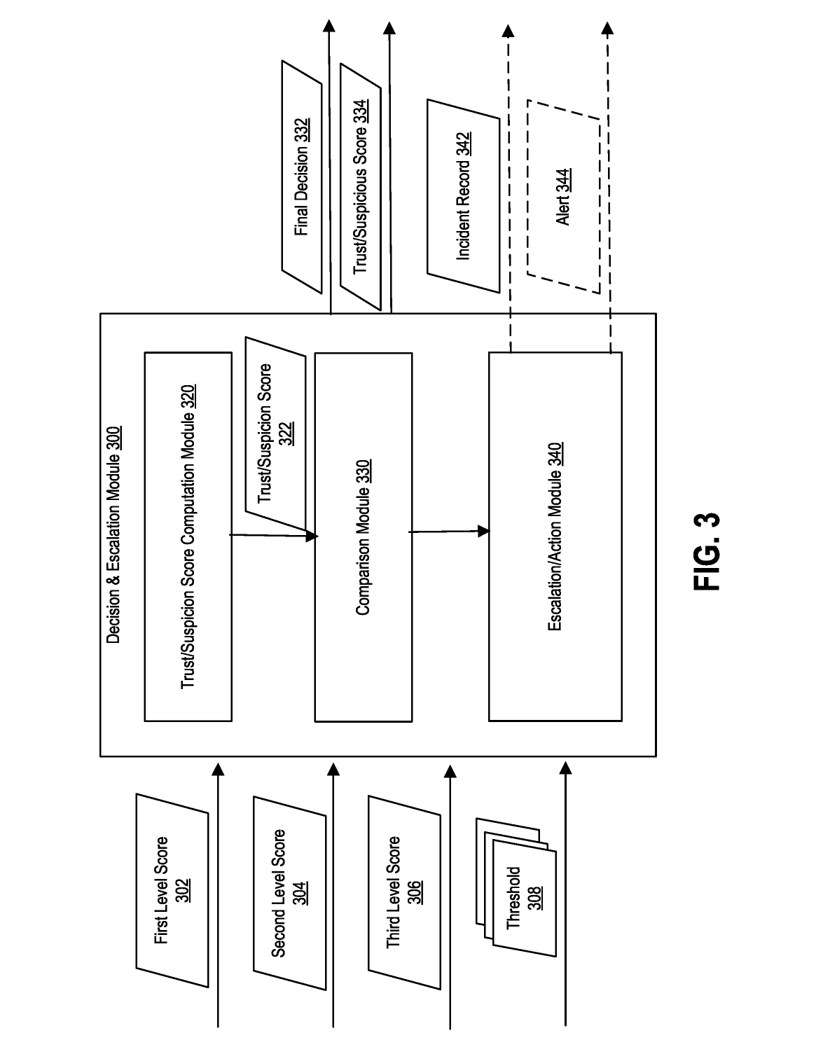

FIG. 3 is a block diagram of an example decision and escalation module 300, according to some aspects of the present disclosure. In some aspects, the decision and escalation module 140 in FIG. 1 is implemented as the decision and escalation module 300.

In some aspects, the decision and escalation module 300 includes a trust/suspicion score computation module 320 configured to compute a trust/suspicion score 322 for a challenge based on a first level score 302 for the challenge, a second level score 304 for the challenge, and a third level score 306 for the challenge. In some aspects, each level score 302, 304, 306 is received from the multi-level challenge verification module 138 (FIG. 1) or 200 (FIG. 2). In some aspects, each level score 302, 304, 306 is combined into the trust/suspicion score 322 using weighted sum.

In some aspects, the decision and escalation module 300 includes a comparison module 330 configured to determine whether the trust/suspicion score 322 (e.g., from trust/suspicion score computation module 320) meets or exceeds a first pre-defined threshold. If the trust/suspicion score 322 meets or exceeds the first pre-defined threshold, the decision and escalation module 140 makes a determination that the user 114 successfully performed the challenge.

In some aspects, the decision and escalation module 300 includes an escalation/action module 340. If the trust/suspicion score 322 is less than the first pre-defined threshold but meets or exceeds a second pre-defined threshold, the escalation/action module 340 is configured to optionally repeat the challenge or trigger one or more additional and different challenges (e.g., by invoking the challenge code generator module 136). If the trust/suspicion score 322 is less than the second pre-defined threshold or if the user 114 failed multiple challenges, the escalation/action module 340 is configured to generate an incident record 343 and perform at least one of the following actions: escalate to a human proctor for manual review (e.g., generate and transmit an optional alert 344 to the human proctor); pause, terminate, or invalidate the online session (e.g., pause, terminate, or invalidate the online examination); or trigger one or more other online presence and liveness verification processes (e.g., reflection-based liveness checks).

In some aspects, the decision and escalation module 300 is configured to aggregate multiple trust/suspicion scores 322 for multiple challenges over the course of the online session into a final decision 332 (e.g., using weighted averaging or voting over the scores). The decision and escalation module 300 is further configured to update a trust/suspicion score 334 for the online session based on the final decision 332. In some aspects, the trust/suspicion score 334 can be stored in a database (e.g., trust/suspicion score database 154 in FIG. 1).

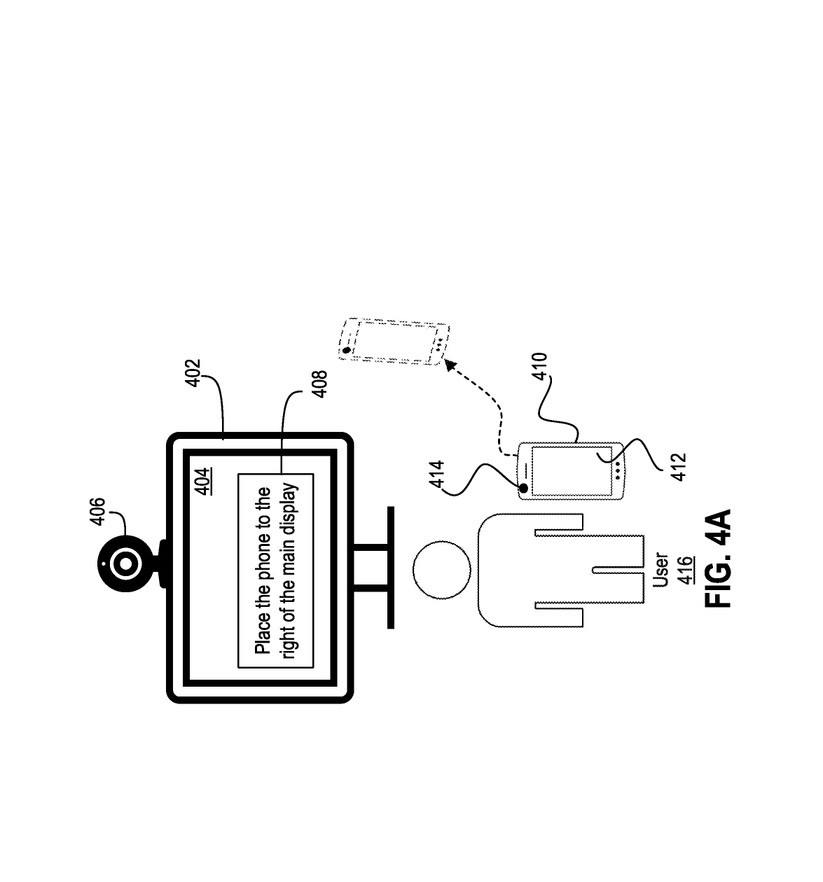

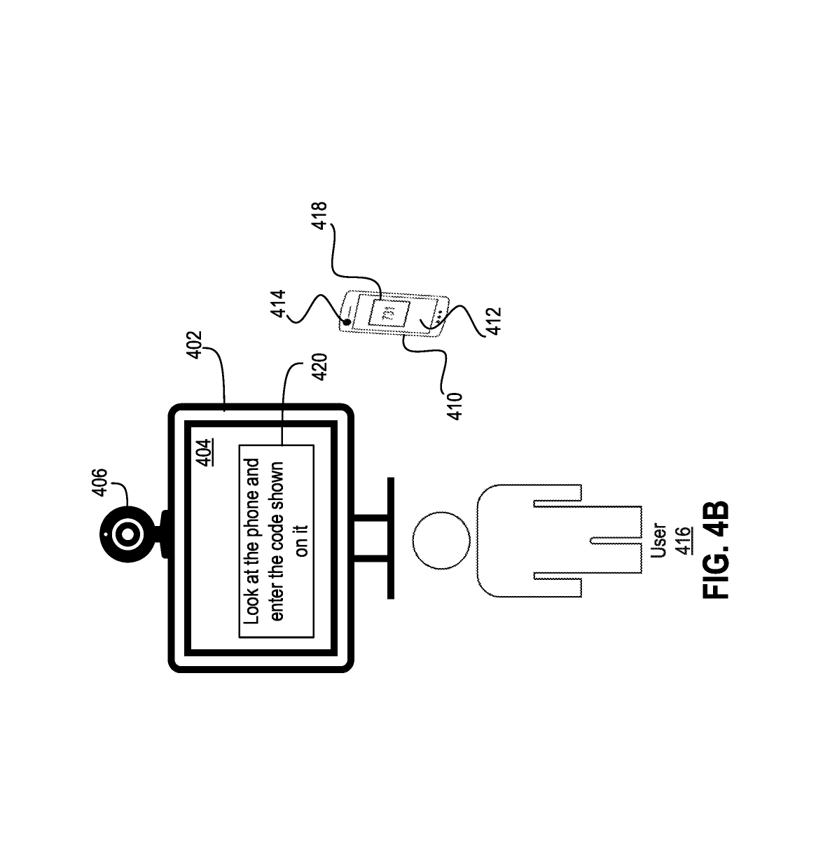

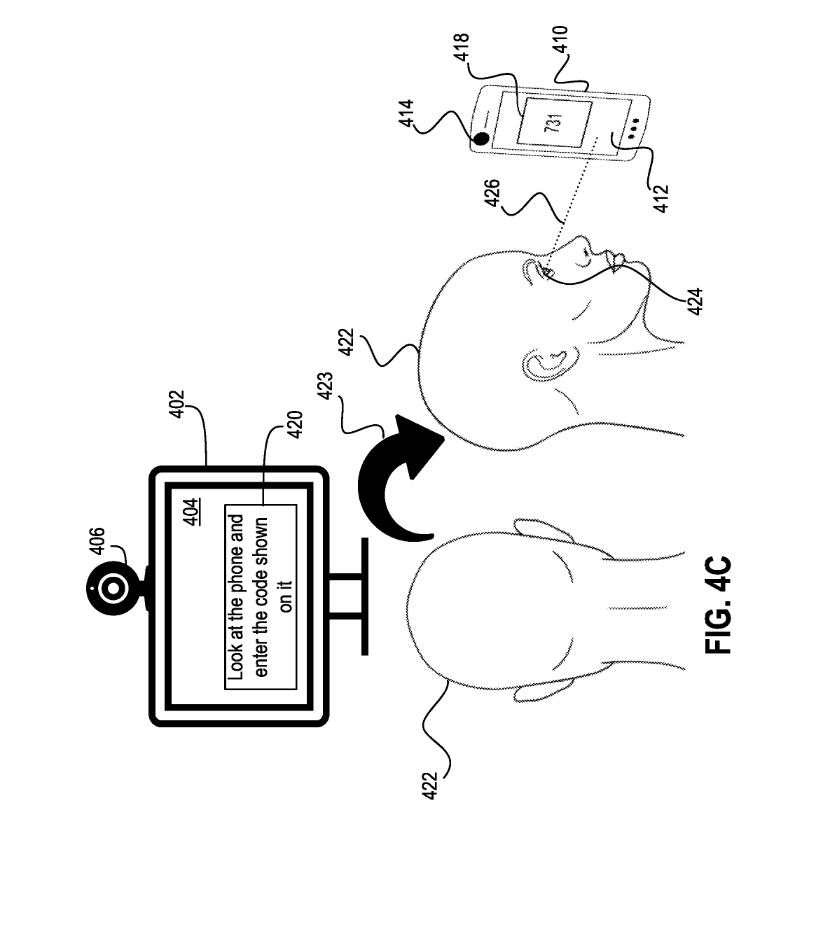

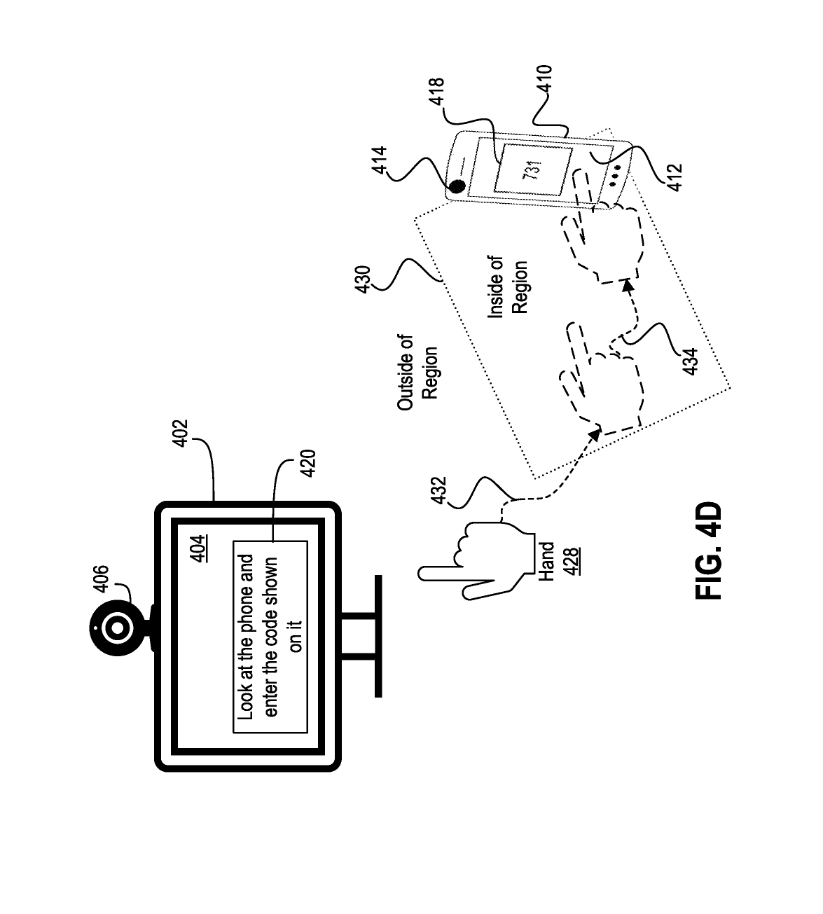

FIG. 4A is an example first instruction 408 presented during an online session, according to some aspects of the present disclosure. In some aspects, the pairing module 132 (FIG. 1) invokes the first display module 122 (FIG. 1) to display the first instruction 408 to a user 416 (e.g., user 114 in FIG. 1) on a first display 404 (i.e., main display) (e.g., first display 104 in FIG. 1) of a first computing device 402 (e.g., first computing device 402), where the first instruction 408 prompts the user 416 to position or place a second computing device 410 (e.g., smartphone) to a side of the first computing device 402/first display 404. For example, the user 416 can be instructed to position the second computing device 410 to a right of the first display 404. The second computing device 410 is positioned such that a second camera 414 of the second computing device 410 is capable of capturing at least a side view of a head of the user 416 and a region where one or more hands of the user 416 can appear.

After the second computing device 410 is positioned to the side of the first computing device 402/first display 404, the pairing module 132 is configured to: (1) invoke the first camera module 124 (FIG. 1) which in turn triggers a first camera 406 of the first computing device 402 to capture a continuous first video data stream of the user 416 during the online session, and (2) invoke the second camera module 128 (FIG. 1) which in turn triggers the second camera 414 to capture a continuous second video data stream of the user 416 during the online session.

FIG. 4B is an example second instruction 420 presented during the same online session of FIG. 4A, according to some aspects of the present disclosure. In some aspects, after each camera 406, 414 is triggered to capture a respective video data stream of the user 416, the challenge code generator module 136 (FIG. 1) is configured to initiate a challenge by: (1) invoking the second display module 126 (FIG. 1) to display a challenge code 418 (e.g., “731”) on a second display 412 of the second computing device 410, and (2) invoking the first display module 122 (FIG. 1) to display the second instruction 420 to the user 416 on the first display 404, where the second instruction 420 prompts the user 416 to look at the second display 412 and input the challenge code 418 using the second computing device 410. In some aspects, the challenge code 418 and the second instruction 420 are simultaneously displayed on the second display 412 and the first display 404, respectively.

FIG. 4C is one or more example physical actions detected during the same online session of FIG. 4A, according to some aspects of the present disclosure. In some aspects, after the challenge is initiated, the multi-level challenge verification module 138 (FIG. 1) or 200 (FIG. 2) verifies whether a head 422 of the user 416 makes a head turn 423 towards the second computing device 410/second display 412 during the challenge. In some aspects, the multi-level challenge verification module 138 or 200 verifies whether a gaze 426 of one or more eyes 424 of the user 416 is directed towards the second display 412 during the challenge.

FIG. 4D is one or more example additional physical actions detected during the same online session of FIG. 4A, according to some aspects of the present disclosure. In some aspects, after the challenge is initiated, the multi-level challenge verification module 138 (FIG. 1) or 200 (FIG. 2) verifies whether a hand 428 of the user 416 made one or more hand movements (e.g., 432, 434) towards the second computing device 410/second display 412 during the challenge. Specifically, the multi-level challenge verification module 138 or 200 detects one or more hand regions of the user 416, tracks one or more hand movements (e.g., 432, 434) of the one or more hand regions during the challenge, and determines whether the hand 428 of the user 516 moves from outside of region 430 representing a vicinity of the second computing device 410/second display 412 and into the region 430 representing the vicinity of the second computing device 410/second display 412 during the challenge, based on the tracked hand movements (e.g., 432, 434).

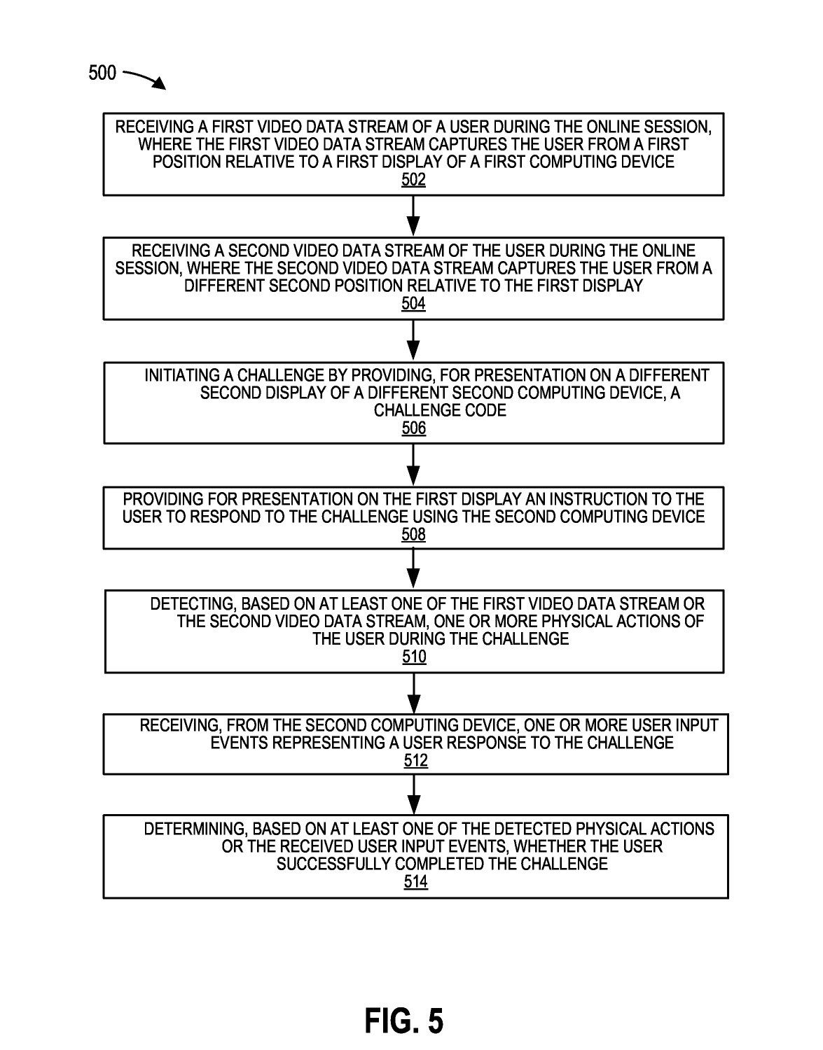

FIG. 5 is flow diagram of an example method 500 for verifying live user presence in an online session, according to some aspects of the present disclosure. At block 502, the method 500 includes receiving a first video data stream of a user during the online session, where the first video data stream captures the user from a first position relative to a first display of a first computing device.

At block 504, the method 500 includes receiving a second video data stream of the user during the online session, where the second video data stream captures the user from a different second position relative to the first display.

At block 506, the method 500 includes initiating a challenge by providing, for presentation on a different second display of a different second computing device, a challenge code.

At block 508, the method 500 includes providing, for presentation on the first display, an instruction to the user to respond to the challenge using the second computing device.

At block 510, the method 500 includes detecting, based on at least one of the first video data stream or the second video data stream, one or more physical actions of the user during the challenge.

At block 512, the method 500 includes receiving, from the second computing device, one or more user input events representing a user response to the challenge.

At block 514, the method 500 includes determining, based on at least one of the detected physical actions or the received user input events, whether the user successfully completed the challenge.

In some aspects, blocks 502-514 of the method 500 can be performed by one or more components of the user presence verification system 120 (FIG. 1), the multi-level challenge verification module 200 (FIG. 2), and/or the decision and escalation module 300 (FIG. 3).

Aspects of the present disclosures, such as the user presence verification system 120 (FIG. 1), the multi-level challenge verification module 200 (FIG. 2), and/or the decision and escalation module 300 (FIG. 3), can be implemented using hardware, software, or a combination thereof and can be implemented in one or more computer systems or other processing systems. In an aspect of the present disclosures, features are directed toward one or more computer systems capable of carrying out the functionality described herein. An example of such a computer system 20 is shown in FIG. 6. The user presence verification system 120 (FIG. 1), the multi-level challenge verification module 200 (FIG. 2), and/or the decision and escalation module 300 (FIG. 3)can include some or all of the components of the computer system 20.

FIG. 6 is a block diagram illustrating the computer system 20 on which aspects of systems and methods for AI-driven visual cues (e.g., markers, pointers, highlights, etc.) for contextual navigation within graphical user interfaces may be implemented in accordance with an exemplary aspect. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include aw single or multiple sets of processors having single or multiple cores. The processor 21 may execute one or more computer-executable code implementing the techniques of the present disclosure. For example, any of commands/steps discussed in FIGS. 1-5 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term "module" as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module’s functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer’s specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for verifying live user presence in an online session, comprising:
receiving a first video data stream of a user during the online session, wherein the first
video data stream captures the user from a first position relative to a first display of a first computing device;
receiving a second video data stream of the user during the online session, wherein the second video data stream captures the user from a different second position relative to the first display;
initiating a challenge by providing, for presentation on a different second display of a different second computing device, a challenge code;
providing, for presentation on the first display, an instruction to the user to respond to the challenge using the second computing device;
detecting, based on at least one of the first video data stream or the second video data stream, one or more physical actions of the user during the challenge;
receiving, from the second computing device, one or more user input events representing a user response to the challenge; and
determining, based on at least one of the detected physical actions or the received user input events, whether the user successfully completed the challenge.

2. The method of claim 1, wherein the instruction and the challenge code are simultaneously
presented on the first display and the second display, respectively.

3. The method of claim 1, wherein the first video data stream is captured via a first camera
of the first computing device, and the second video data stream is captured via a second camera of the second computing device.

4. The method of claim 1, wherein the second computing device is positioned to a side of
the first computing device, and the second computing device is positioned to a side of the user when the user is in front of and facing the first display.

5. The method of claim 1, wherein the second computing device comprises a smartphone.

6. The method of claim 1, wherein the online session comprises an online examination
session, and the user is an examinee.

7. The method of claim 6, further comprising:
providing examination content for presentation on the first display in response to
determining the user successfully completed the challenge.

8. The method of claim 6, further comprising:
triggering at least one action in response to determining the user did not successfully
complete the challenge, wherein the at least one action comprises at least one of pausing the online examination session, notifying a proctor, initiating an additional challenge, or recording that the user did not successfully complete the challenge.

9. The method of claim 1, wherein the detecting comprises:
determining, based on the first video stream, whether a head of the user rotates towards
the second computing device during the challenge; and
determining, based on the second video stream, whether a face of the user orientates towards the second display during the challenge.

10. The method of claim 9, wherein the detecting further comprises:
detecting, in one or more individual video frames of the second video stream, at least one hand region of the user corresponding to a physical action of the user;
tracking a movement of the at least one hand region during the challenge; and
determining, based on the tracked movement, whether the at least one hand region moves from outside of a region proximate to the second computing device to inside of the region during the challenge.

11. The method of claim 10, wherein the detecting further comprises:
determining a time interval during which the at least one hand region moves towards the second computing device; and
determining whether one or more timestamps of the received user input events fall within the time interval.

12. The method of claim 11, wherein the detecting further comprises:
estimating, based on at least one of the first video stream or the second video stream, a gaze direction of the user during the challenge; and
determining whether the gaze direction is directed towards the second display for a pre-determined duration, wherein the pre-determined duration represents a minimum amount of time required to at least one of read the challenge code on the second display or respond to the challenge using the second computing device.

13. The method of claim 12 wherein the determining comprises:
determining whether the user physically interacted with the second computing device during the challenge;
determining whether the user response matches the challenge code; and
determining the user did not successfully complete the challenge in response to determining at least one of the user did not physically interact with the second computing device during the challenge or the user response does not match the challenge code.

14. The method of claim 13, wherein the user did not physically interact with the second
computing device during the challenge if the head of the user does not rotate towards the second computing during the challenge, the face of the user does not orientate towards the second display during the challenge, the at least one hand region does not move from outside of the region to inside of the region during the challenge, the timestamps of the received user input events do not fall within the time interval, or the gaze direction is not directed towards the second display for the pre-determined duration.

15. A system for verifying live user presence in an online session, comprising:
one or more memories configured to store executable instructions; and
one or more processors communicatively coupled with the one or more memories and
configured, individually or in any combination, to execute the executable instructions to:
receive a first video data stream of a user during the online session, wherein the first video data stream captures the user from a first position relative to a first display of a first computing device;
receive a second video data stream of the user during the online session, wherein the second video data stream captures the user from a different second position relative to the first display;
initiate a challenge by providing, for presentation on a different second display of a different second computing device, a challenge code;
provide, for presentation on the first display, an instruction to the user to respond to the challenge using the second computing device;
detect, based on at least one of the first video data stream or the second video data stream, one or more physical actions of the user during the challenge;
receive, from the second computing device, one or more user input events representing a user response to the challenge; and
determine, based on at least one of the detected physical actions or the received user input events, whether the user successfully completed the challenge.

16. The system of claim 15, wherein the instruction and the challenge code are
simultaneously presented on the first display and the second display, respectively.

17. The system of claim 15, wherein the first video data stream is captured via a first camera
of the first computing device, and the second video data stream is captured via a second camera of the second computing device.

18. The system of claim 15, wherein the second computing device is positioned to a side of
the first computing device, and the second computing device is positioned to a side of the user when the user is in front of and facing the first display.

19. The system of claim 15, wherein the second computing device comprises a smartphone.

20. A non-transitory computer-readable medium having instructions verifying live user
presence in an online session, the instructions are executable by one or more processors, individually or in any combination, to:
receive a first video data stream of a user during the online session, wherein the first video data stream captures the user from a first position relative to a first display of a first computing device;
receive a second video data stream of the user during the online session, wherein the second video data stream captures the user from a different second position relative to the first display;
initiate a challenge by providing, for presentation on a different second display of a different second computing device, a challenge code;
provide, for presentation on the first display, an instruction to the user to respond to the challenge using the second computing device;
detect, based on at least one of the first video data stream or the second video data stream, one or more physical actions of the user during the challenge;
receive, from the second computing device, one or more user input events representing a user response to the challenge; and
determine, based on at least one of the detected physical actions or the received user input events, whether the user successfully completed the challenge.
